(19) United States
(12) Patent Application Publication
(10) Pub. No.: US 2023/0327104 A1
(43) Pub. Date: Oct. 12, 2023

(54) CATHODE MATERIALS

(71) Applicant: JOHNSON MATTHEY PUBLIC LIMITED COMPANY, London (GB)

(72) Inventors: Carlos MARIN FLORIDO, Reading (GB); Eva-Maria HAMMER, Reading (GB); Srinivasarao POPURI, Reading (GB)

(21) Appl. No.: 18/041,517

(22) PCT Filed: Aug. 12, 2021
(86) PCT No.: PCT/GB2021/052094

§ 371 Date: Feb. 13, 2023

(30) Foreign Application Priority Data
Aug. 13, 2020 (GB) 2012628.0

(51) Int. Cl. H01M 4/525; C01G 53/00

(52) U.S. Cl. CPC H01M 4/525; C01G 53/42; C01P 2002/54; C01P 2002/77; C01P 2004/03; C01P 2004/61; C01P 2004/62; C01P 2004/84; C01P 2006/40

(57) ABSTRACT

The invention relates to improved particulate lithium nickel oxide materials which are useful as cathode materials in lithium secondary batteries, and methods of their manufacture.

### FIELD OF THE INVENTION

The present invention generally relates to lithium nickel composite oxide materials which have utility as cathode materials in secondary lithium-ion batteries, and to improved processes for making lithium nickel composite oxide materials.

### BACKGROUND OF THE INVENTION

Lithium nickel composite oxide materials having a layered structure find utility as cathode materials in secondary lithium-ion batteries. Typically, lithium nickel composite oxide materials are produced by mixing nickel metal precursors, such as hydroxides or oxyhydroxides, with a source of lithium, and then calcining the mixture. During the calcination process, the nickel metal precursor is lithiated and oxidised and undergoes a crystal structure transformation via intermediate phases to form the desired layered LiNiO₂ structure.

The nickel metal precursors are typically formed by co-precipitation of a mixed metal salt solution in the presence of ammonia at high pH. Formation of the desired crystalline phase is then carried out by a calcination process involving holding the mixture of precursor and lithium source at an elevated temperature, such as 700° C. Such processes provide lithium nickel composite oxide materials in the form of secondary particles comprising a large number of small crystal grains (also known as primary particles) which are separated by grain boundaries.

WO2017/189887A1 describes a method of manufacturing an electrochemically active particle, the method comprising the production of a first mixture comprising lithium hydroxide or its hydrate and a precursor hydroxide comprising nickel, and calcining the first mixture to a maximum temperature of 700° C. Example 1 describes the preparation of two samples of polycrystalline 2D α—NaFeO₂—type layered structure particles. A precursor hydroxide is mixed with LiOH and then heated from 25° C. to 450° C. at 5° C. per minute with a soak time of 2 hours followed by a second ramp at 2° C. per minute to a maximum temperature of 700° C. (or 680° C.) for a soak time of 6 hours.

Such materials can provide a good electrochemical performance but may suffer from cracking or particle breakage under pressure, for example during densification processes used in electrode fabrication. This can lead to a reduction in electrochemical performance upon repeated charge-discharge cycles and a reduction in battery lifetime. Furthermore, such materials may suffer from a loss of power output as discharge rates are increased.

There remains a need for improved processes for making lithium nickel composite oxide materials, and for lithium nickel composite oxide materials with improved electrochemical properties.

### SUMMARY OF THE INVENTION

The present inventors have found that by altering the size and structure of lithium nickel composite oxide particles, improved materials may be produced which offer improved processability with regards to prior art materials, which may either suffer from breakage under compression or handling difficulties due to small particle size, and which offer an improvement in discharge capacity retention upon repeated charge-discharge cycles. It has also been found that such materials may be advantageously produced by altering calcination profiles previously used to form lithium nickel oxide materials. Furthermore, it has been found that the lithium nickel composite oxide materials described herein may be blended with other lithium nickel composite oxide materials to enable the formation of electrodes with a reduction in the compression required to achieve target electrode densities, and to provide electrodes with improved retention of discharge capacity at high discharge rates.

Therefore, in a first aspect of the invention there is provided a particulate lithium nickel composite oxide material satisfying the following requirements:
(i) the lithium nickel composite oxide has a composition according to formula (1):

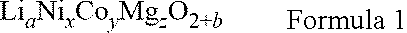

in which:
$$0.8 \leq \text{a} \leq 1.2$$
$$0.7 \leq \text{x} < 1$$
$$0 \leq \text{y} \leq 0.3$$
$$0 < \text{z} \leq \text{0} \text{.2}$$
$$\text{-} 0.2 \leq \text{b} \leq \text{0} \text{.2}$$
$$\text{x} + \text{y} + \text{z} = 1 ;$$
(ii) the lithium nickel composite oxide material has a volume-based particle size distribution such that the D50 is in the range of and including 2 to 7 µm;
(iii) the average primary particle size of the lithium nickel composite oxide material is in the range of and including 0.5 to 4 µm.

It has also been found that by further optimising the particle size distribution, lithium nickel composite oxide materials may be provided which, when formed into an electrode, provide enhanced discharge capacity retention upon repeated cycling. It is therefore preferred that the lithium nickel composite oxide materials have a particle size distribution characterised by a D90 < 10 µm.

The process as described herein provides advantageous materials according to the first aspect in a single calcination process without the requirement for repeated heating and cooling cycles and associated process inefficiencies.

Therefore, in a second aspect of the invention, there is provided a process for preparing a lithium nickel composite oxide material with a composition according to Formula 1, the process comprising the steps of:
(i) providing a precursor of the lithium nickel composite oxide with a volume-based particle size distribution such that the D50 is in the range of and including 1 to 7 µm;
(ii) mixing the precursor with at least one lithium-containing compound;
(iii) calcining the mixture to form the lithium nickel composite oxide material, the calcination comprising heating to a temperature in the range of and including 650° C. to 725° C. for a period of from 2 to 8 hours; and subsequently heating to a temperature in the range of and including 775° C. to 875° C.

In a third aspect of the invention, there is provided a lithium nickel composite oxide compound obtained or obtainable by a process according to the second aspect.

The particles of the first aspect may additionally be advantageously combined with other lithium nickel composite oxide materials. Such combinations have been found to provide benefits during the formation of electrodes associated with a reduction in the pressure required during electrode densification processes to achieve suitable electrode densities. In addition, electrodes comprising the combination of particles provide an increase in the retention of discharge capacity at high discharge rates. Therefore, in a fourth aspect of the invention there is provided a positive electrode active material comprising:
(i) a first particulate lithium nickel composite oxide with a composition according to Formula 1 and with an average primary particle size in the range of and including 0.5 to 4 µm;
(ii) a second particulate lithium nickel composite oxide material in the form of secondary particles comprising a plurality of crystal grains separated by grain boundaries.

In a fifth aspect of the invention there is provided a method of forming an electrode comprising the steps of:
(i) forming an electrode slurry comprising (a) a first particulate lithium nickel composite oxide material with a composition according to Formula 1 and with an average primary particle size in the range of and including 0.5 to 4 µm; and (b) a second particulate lithium nickel composite oxide material in the form of secondary particles comprising a plurality of crystal grains separated by grain boundaries;
(ii) applying the electrode slurry to a current collector and drying;
(iii) calendaring the electrode.

It may be preferred that step (i) of the method of the fifth aspect comprises forming an electrode slurry comprising a positive electrode active material according to the fourth aspect.

In a sixth aspect of the invention there is provided an electrode comprising a lithium nickel composite oxide compound of the first aspect or the third aspect, an electrode comprising a lithium nickel composite oxide compound formed by the process of the second aspect, an electrode comprising a positive electrode active material according to the fourth aspect, or an electrode formed according to the process of the fifth aspect.

In a seventh aspect of the invention there is provided an electrochemical cell comprising an electrode according to the sixth aspect.

### BRIEF DESCRIPTION OF THE DRAWINGS

FIG. 1 shows a scanning electron microscopy (SEM) image of the precursor material formed in Example 1.

FIG. 2 shows a scanning electron microscopy (SEM) image of the lithium nickel composite oxide material formed in Example 2.

FIG. 3 shows a top scanning electron microscopy (SEM) image of Electrode A formed in Example 9.

FIG. 4 shows a top scanning electron microscopy (SEM) image of Electrode B formed in Example 9.

FIG. 5 shows the increase in density with increased uniaxial pressure applied to Electrodes C in Example 10.

FIG. 6 shows the increase in density with increased uniaxial pressure applied to Electrodes D in Example 10.

FIG. 7 shows the increase in density with increased uniaxial pressure applied to Electrodes E in Example 10.

### DETAILED DESCRIPTION

Preferred and/or optional features of the invention will now be set out. Any aspect of the invention may be combined with any other aspect of the invention unless the context demands otherwise. Any of the preferred and/or optional features of any aspect may be combined, either singly or in combination, with any aspect of the invention unless the context demands otherwise.

The present invention provides lithium nickel composite oxide materials according to Formula 1. The lithium nickel composite oxide materials are crystalline or substantially crystalline material. The materials may have a α—NaFeO₂—type structure.

In Formula 1, 0.8 ≤ a ≤ 1.2. It may be preferred that a is greater than or equal to 0.90, or greater than or equal to 0.95. It may be preferred that a is less than or equal to 1.10, or less than or equal to 1.05. It may be preferred that 0.90 ≤ a ≤ 1.10, for example 0.95 ≤ a ≤ 1.05. It may be preferred that a = 1.

In Formula I, 0.7 ≤ x < 1. It may be preferred that 0.75 ≤ x < 1, 0.80 ≤ x < 1, 0.85 ≤ x < 1 or 0.90 ≤ x < 1. It may be preferred that x is less than or equal to 0.99, 0.98, 0.97, 0.96 or 0.95. It may be preferred that 0.75 ≤ x ≤ 1, for example 0.75 ≤ x ≤ 0.99, 0.75 ≤ x ≤ 0.98, 0.75 ≤ x ≤ 0.97, 0.75 ≤ x ≤ 0.96 or 0.75 ≤ x ≤ 0.95. It may be further preferred that 0.80 ≤ x < 1, for example 0.80 ≤ x ≤ 0.99, 0.80 ≤ x ≤ 0.98, 0.80 ≤ x ≤ 0.97, 0.80 ≤ x ≤ 0.96 or 0.80 ≤ x ≤ 0.95. It may also be preferred that 0.85 ≤ x < 1, for example 0.85 ≤ x ≤ 0.99, 0.85 ≤ x ≤ 0.98, 0.85 ≤ x ≤ 0.97, 0.85 ≤ x ≤ 0.96 or 0.85 ≤ x ≤ 0.95.

In Formula 1, 0 ≤ y ≤ 0.3. It may be preferred that y is greater than or equal to 0.01, 0.02 or 0.03. It may be preferred that y is less than or equal to 0.2, 0.15, 0.1 or 0.05. It may also be preferred that 0.01 ≤ y ≤ 0.3, 0.02 ≤ y ≤ 0.3, 0.03 ≤ y ≤ 0.3, 0.01 ≤ y ≤ 0.25, 0.01 ≤ y ≤ 0.2, or 0.01 ≤ y ≤ 0.15.

In Formula I, 0 < z ≤ 0.2. It may be preferred that 0 < z ≤ 0.15, 0 < z ≤ 0.10, 0 < z ≤ 0.05, 0 < z ≤ 0.04, 0 < z ≤ 0.03, or 0 < z ≤ 0.02.

In Formula I, -0.2 ≤ b ≤ 0.2. It may be preferred that b is greater than or equal to -0.1. It may also be preferred that b is less than or equal to 0.1. It may be further preferred that -0.1 ≤ b ≤ 0.1, or that b is 0 or about 0.

It may be preferred that 0.8 ≤ a ≤ 1.2, 0.75 ≤ x < 1.0 < y ≤ 0.25, 0 < z ≤ 0.2, -0.2 ≤ b ≤ 0.2 and x + y + z = 1. It may also be preferred that 0.8 ≤ a ≤ 1.2, 0.80 ≤ x < 1, 0 < y ≤ 0.2, 0 < z ≤ 0.2, -0.2 ≤ b ≤ 0.2 and x + y + z = 1. It may be further preferred that 0.8 ≤ a ≤ 1.2, 0.85 ≤ x < 1, 0 < y ≤ 0.15, 0 < z ≤ 0.15, -0.2 ≤ b ≤ 0.2 and x + y + z = 1.

The lithium nickel composite oxide materials have a volume-based particle size distribution such that the D50 is in the range of and including 2 to 7 µm. The term D50 as used herein refers to the median particle diameter of the volume-weighted distribution. The D50 may be determined by using a laser diffraction method. For example, the D50 may be determined by suspending the particles in water and analysing using a Malvern Mastersizer 3000. It may be preferred that the D50 is in the range of and including 2 to 5 µm.

The average primary particle size of the lithium nickel composite oxide material is in the range of and including 0.5 to 4 µm. As used herein the term primary particle means a particle that is not formed from smaller particles separated by grain boundaries. It may be preferred that the average primary particle size is in the range of and including 0.5 to 3 µm. It may be further preferred that the primary particle size is in the range of and including 0.5 to 2 µm.

The average primary particle size may be determined by scanning electron microscopic observation using image analysis to determine the arithmetic average of the equivalent spherical diameters. For example, using a scanning electron microscope, observation is performed at a magnification of 1,000 to 10,000 in accordance with the particle size. About two hundred particles having recognisable profiles are selected for analysis. Image analysis used to determine the equivalent diameter of the primary particles as the arithmetic equivalent of spherical diameters and the arithmetic average is calculated to determine the average primary particle size.

The combination of value of a D50 in a range of and including 2 to 7 µm, and in particular a D50 in the range of and including 2 to 5 µm, and an average primary particle of 0.5 to 4 µm indicates that the lithium nickel composite oxide particles are composed of a small number of primary particles and offer improved processability during electrode formation. Advantageously, it has additionally been found that when the lithium nickel composite oxide materials are formed into an electrode the particles are substantially in the form of monolithic particles. As used herein monolithic particles means particles which are formed from only one primary particle.

Preferably, the volume-based particle size distribution is such that the D90 is less than 10 µm. The D90 may be determined by using a laser diffraction method. The D90 is the particle size corresponding to a cumulative percentage of 90 from the smaller particle size side. It may be further preferred that the D90 is less than 9 µm, or less than 8 µm.

In combination with the D50 and average primary particle ranges as described herein, materials with a D90 value of less than 10 µm have been found to have enhanced discharge capacity retention upon repeated charge-discharge cycles. It may be particularly preferred that the D50 is in the range of and including 2 to 5 µm and the D90 is less than 10 µm, such as a D90 greater than 5 µm and less than 10 µm.

Preferably, the length of the c-axis of the lithium nickel composite oxide materials is less than 14.190 angstrom as determined by a Rietveld analysis of the powder x-ray diffraction pattern of the lithium nickel composite oxide material, such as between 14.180 and 14.190 angstrom. An increase in c-axis parameter has above 14.190 may lead to a reduction in electrochemical performance, such as discharge capacity retention upon repeated charge-discharge cycles.

The lithium nickel composite oxide materials as described herein may be prepared using a process comprising a step of providing a precursor of the lithium nickel composite oxide with a volume-based particle size distribution such that the D50 is in the range of and including 1 to 7 µm.

The precursor of the lithium nickel composite oxide is a compound which comprises nickel and one or more additional metals and which may be converted to lithium nickel composite oxide with a layered structure upon reaction with a lithium-containing compound and heat treatment. The nickel metal precursor may be a precipitated nickel metal compound, for example it may be a co-precipitated mixed nickel metal compound.

The precursor of the lithium nickel composite oxide may be a nickel metal hydroxide, a nickel metal oxyhydroxide or a mixture thereof.

It may be preferred that the precursor of the lithium nickel composite oxide comprises a compound according to formula 2:

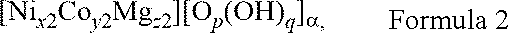

wherein:

$$0.7 \leq \text{x} 2 < 1$$

$$0 \leq \text{y} 2 \leq 0.3$$

$$0 \leq \text{z2} \leq \text{0} \text{.2}$$

wherein p is in the range 0 ≤ p < 1; q is in the range 0 < q ≤ 2; x2 + y2 + z2 = 1; and α is selected such that the overall charge balance is 0. Preferably, p is 0, and q is 2. In other words, preferably the precursor of the lithium nickel composite oxide is a pure metal hydroxide having the general formula [Niₓ₂Co_{y2}Mg_{z2}][(OH)_{2]α}. As discussed above, α is selected such that the overall charge balance is 0. α may therefore satisfy 0.5 ≤ α ≤ 1.5. For example, α may be 1.

It will be understood by the skilled person that the values x2, y2, and z2, are selected so as to achieve the desired composition in Formula 1 after the process as described herein.

It may be preferred that 0.75 ≤ x2 < 1, 0 < y2 ≤ 0.25, 0 ≤ z2 ≤ 0.2. For example, the precursor of the lithium nickel composite oxide may be a compound of formula Ni_{0.90}Co_{0.05}Mg_{0.05}(OH)₂, Ni_{0.90}CO_{0.06}Mg_{0.04}(OH)₂, Ni_{0.90}CO_{0.07}Mg_{0.03}(OH)₂, Ni_{0.91}CO_{0.08}Mg_{0.01}(OH)₂, Ni_{0.88}CO_{0.08}Mg_{0.04}(OH)₂, Ni_{0.90}CO_{0.08}Mg_{0.02}(OH)₂, or Ni_{0.93}Co_{0.06}Mg_{0.01}(OH)₂.

It may also be preferred that the precursor is a nickel cobalt hydroxide, a nickel metal oxyhydroxide or a mixture thereof, and that a magnesium-containing compound, such as a magnesium salt, for example magnesium hydroxide, is mixed with the precursor prior to calcination.

Typically, the particles of the precursor of the lithium nickel composite oxide are provided in the form of secondary particles comprising a plurality of crystal grains (primary particles).

The precursor materials are produced by methods well known to the person skilled in the art. Typically, these methods involve the co-precipitation of a mixed metal hydroxide from a solution of metal salts, such as metal sulfates, for example in the presence of ammonia and a base, such as NaOH. In some cases, suitable nickel metal, such as mixed metal hydroxides, may be obtainable from commercial suppliers known to the skilled person.

The precursor of the lithium nickel composite oxide is provided with a volume-based particle size distribution such that the D50 is in the range of and including 1 to 7 µm. It has been found that the use of a precursor material within this size range enables the production of the lithium nickel composite oxides with a controlled D50 and average primary particle size as described herein. It may be preferred that the D50 is in the range of and including 1 to 5 µm, 2 to 4 µm, or about 3 µm.

The precursor is mixed with at least one lithium-containing compound. Suitable lithium-containing compounds that may be mixed with the precursor particles include lithium salts, such as inorganic lithium salts. Lithium hydroxide may be particularly preferred.

The mixture is then calcined to form the lithium nickel composite oxide material. The calcination comprising heating to a temperature in the range of and including 650° C. to 725° C. Heating to a temperature of at least 650° C. ensures conversion to the desired layered structure whilst maintaining the temperature below 725° C. restricts particle growth at this stage of the calcination.

The mixture is heated to a temperature in the range of and including 650° C. to 725° C. for a period of from 2 to 8 hours. Heating for at least 2 hours in this temperature range ensures conversion to the desired layered structure. It has been found that greater than eight hours in this temperature range is not required to form the desired structure and reduces the energy efficiency of the overall calcination process.

Subsequently the calcination profile comprises heating to a temperature in the range of and including 775° C. to 875° C. It has been found that heating above 775° C. enables the formation of the desired primary particle size. Heating above 875° C. has been found to be detrimental to electrochemical performance of the formed lithium nickel composite oxide material, for example a reduction in discharge capacity and capacity retention upon repeated charge-discharge cycles. It has also been observed that heating above 875° C. leads an increase in lithium oxides impurity levels. Preferably, the calcination profile comprises heating to a temperature in the range of and including 775 to 850° C., 775 to825° C. or about 800° C.

Typically, the mixture is heated to a temperature in the range of and including 775° C. to 875° C. for a period of from 4 to 20 hours. Heating for at least 4 hours enables the formation of the desired primary particle size. Heating for longer than 20 hours has been found to provide materials with a reduced first cycle discharge capacity. It may be preferred that the period is of from 4 to 12 hours, or of from 6 to 10 hours.

It may be preferred that the calcination profile comprises a first lower temperature hold, and that the process comprises a calcination comprising heating to a temperature in the range of and including 350° C. to 550° C. for a period of from 2 to 8 hours, heating to a temperature in the range of and including 650° C. to 725° C. for a period of from 2 to 8 hours; and subsequently heating to a temperature in the range of and including 775° C. to 875° C. It may be further preferred that the first lower temperature hold is carried out at a temperature in the range of and including 400° C. to 500° C. It may be even further preferred that the first lower temperature hold is carried out at a temperature in the range of and including 400° C. to 500° C. for a period of from 1 to 4 hours. The inclusion of a first lower temperature hold can provide a lithium nickel composite oxide material with a more ordered structure.

The calcination step may be carried out under a CO₂-free atmosphere. For example, CO₂₋free air may be flowed over the materials during heating and optionally during cooling. The CO₂-free air may, for example, be a mix of oxygen and nitrogen. Preferably, the atmosphere is an oxidising atmosphere. As used herein, the term “CO₂-free” is intended to include atmospheres including less than 100 ppm CO₂, e.g. less than 50 ppm CO₂, less than 20 ppm CO₂ or less than 10 ppm CO₂. These CO₂ levels may be achieved by using a CO₂ scrubber to remove CO₂.

It may be preferred that the CO₂-free atmosphere comprises a mixture of oxygen and nitrogen. It may be further preferred that the mixture comprises nitrogen and oxygen in a ratio of from 1:99 to 90:10, for example from 1:99 to 50:50, 1:99 to 10:90, for example about 7:93.

The calcination may be carried out in any suitable furnace known to the person skilled in the art, for example a static kiln (such as a tube furnace or a muffle furnace), a tunnel furnace (in which static beds of material are moved through the furnace, such as a roller hearth kiln or push-through furnace), or a rotary furnace (including a screw-fed or auger-fed rotary furnace). The furnace used for calcination is typically capable of being operated under a controlled gas atmosphere. It may be preferred to carry out the calcination step in a furnace with a static bed of material, such as a static furnace or tunnel furnace (e.g. a roller hearth kiln or push-through furnace).

Where the calcination is carried out in a furnace with a static bed of material, the high-energy milled intermediate is typically loaded into a calcination vessel (e.g. saggar or other suitable crucible) prior to calcination.

Optionally, a coating step is carried out on the lithium nickel composite oxide material obtained following calcination.

The coating step may comprise contacting the lithium nickel composite oxide with a coating composition comprising one or more coating metal elements. The one or more coating metal elements may be provided as an aqueous solution. Suitably, the one or more coating elements may be provided as an aqueous solution of salts of the one or more coating metal elements, for example as nitrates or sulfates of the one or more coating metals. The one or more coating metal elements may be one or more selected from lithium, nickel, cobalt, manganese, aluminium, magnesium, zirconium, and zinc, such as one or more of lithium, nickel, cobalt, and magnesium.

The coating step typically comprises the step of separating the solid from the coating composition and optionally drying the material. The separation is suitably carried out by filtration, or alternatively the separation and drying may be carried out simultaneously by spray-drying the lithium nickel composite oxide and coating solution. The coated material may be subjected to a subsequent heating step.

The lithium nickel composite oxide material may be sieved after calcination (before or after a coating step if applicable). For example, the particles of lithium nickel composite oxide material may be sieved using a 50 to 60 micron sieve to remove large particles.

Alternatively, or in addition the process may include the step of milling the lithium nickel composite oxide material. The milling may be carried out until the particles reach the desired size and / or particle size distribution. For example, it is preferred that the particles of the lithium nickel composite oxide material are milled until they have a volume particle size distribution such that the D90 is less than 10 µm.

It has also been found that the lithium nickel composite oxide materials as described herein (“first particulate lithium nickel composite oxide material” hereinafter) may be advantageously combined with a second particulate lithium nickel composite oxide material in the form of secondary particles comprising a plurality of crystal grains separated by grain boundaries. The inclusion of the first particulate lithium nickel composite oxide materials in a particulate blend enables a reduction in the pressure required to form electrodes to achieve desired electrode densities and offers an improvement in power output at high discharge rates.

Typically, the second particulate lithium nickel composite oxide material has the layered α—NaFeO₂—type structure.

Preferably, the second lithium nickel composite oxide material has a formula according to Formula 3:

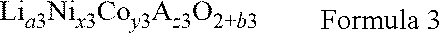

in which: A is one or more of Al, V, Ti, B, Zr, Cu, Sn, Cr, Fe, Ga, Si, Zn, Mg, Sr, Mn, Wand Ca;

$$0.8 \leq \text{a3} \leq 1.2$$

$$0.5 \leq \text{x3} < 1$$

$$0 < \text{y3} \leq 0.5$$

$$0 \leq \text{z3} \leq \text{0} \text{.2}$$

$$\text{-} 0.2 \leq \text{b3} \leq \text{0} \text{.2}$$

$$\text{x3} + \text{y3} + \text{z3} = 1$$

In Formula 3, 0.8 ≤ a3 ≤ 1.2. It may be preferred that a3 is greater than or equal to 0.9, or 0.95. It may be preferred that a3 is less than or equal to 1.1, or less than or equal to 1.05. It may be preferred that 0.90 ≤ a3 ≤ 1.10, for example 0.95 ≤ a3 ≤ 1.05, or that a3 = 0 or about 0.

In Formula 3, 0.5 ≤ x3 < 1. It may be preferred that 0.6 ≤ x3 < 1, for example 0.7 ≤ x3 < 1, 0.75 ≤ x3 < 1, 0.8 ≤ x3 < 1, 0.85 ≤ x3 < 1 or 0.9 ≤ x3 < 1. It may be preferred that x is less than or equal to 0.99, 0.98, 0.97, 0.96 or 0.95. It may be preferred that 0.75 ≤ x3 < 1, for example 0.75 ≤ x3 ≤ 0.99, 0.75 ≤ x3 ≤ 0.98, 0.75 ≤ x3 ≤ 0.97, 0.75 ≤ x3 ≤ 0.96 or 0.75 ≤ x3 ≤ 0.95. It may be further preferred that 0.8 ≤ x3 < 1, for example 0.8 ≤ x3 ≤ 0.99, 0.8 ≤ x3 ≤ 0.98, 0.8 ≤ x3 ≤ 0.97, 0.8 ≤ x3 ≤ 0.96 or 0.8 ≤ x3 ≤ 0.95. It may also be preferred that 0.85 ≤ x3 < 1, for example 0.85 ≤ x3 ≤ 0.99, 0.85 ≤ x3 ≤ 0.98, 0.85 ≤ x3 ≤ 0.97, 0.85 ≤ x3 ≤ 0.96 or 0.85 ≤ x3 ≤ 0.95.

In Formula 3, 0 < y3 ≤ 0.5. It may be preferred that y3 is greater than or equal to 0.01, 0.02 or 0.03. It may be preferred that y3 is less than or equal to 0.4, 0.3, 0.25, 0.2, 0.15, 0.1 or 0.05. It may also be preferred that 0.01 ≤ y3 ≤ 0.5, 0.02 ≤ y3 ≤ 0.5, 0.03 ≤ y3 ≤ 0.5, 0.01 ≤ y3 ≤ 0.4, 0.01 ≤ y3 ≤ 0.3, 0.01 ≤ y3 ≤ 0.25, 0.01 ≤ y3 ≤ 0.20, 0.01 ≤ y3 ≤ 0.1 or 0.03 ≤ y3 ≤ 0.1.

A is one or more of Al, V, Ti, B, Zr, Cu, Sn, Cr, Fe, Ga, Si, Zn, Mg, Sr, Mn, W and Ca. Preferably, A is one or more of Al, V, Ti, B, Zr, Cu, Sn, Cr, Fe, Ga, Si, Zn, Mg, Sr, W and Ca. It may be further preferred that A is at least Mg and / or Al, or A is Al and / or Mg. Where A comprises more than one element, z3 is the sum of the amount of each of the elements making up A.

In Formula 3, 0 ≤ z3 ≤ 0.2. It may be preferred that 0 ≤ z3 ≤ 0.15, 0 ≤ z3 ≤ 0.10, 0 ≤ z3 ≤ 0.05, 0 ≤ z3 ≤ 0.04, 0 ≤ z3 ≤ 0.03, 0 ≤ z3 ≤ 0.02, or that z3 is 0 or about 0.

In Formula I, -0.2 ≤ b3 ≤ 0.2. It may be preferred that b3 is greater than or equal to -0.1. It may also be preferred that b3 is less than or equal to 0.1. It may be further preferred that -0.1 ≤ b ≤ 0.1, or that b3 is 0 or about 0.

It may be preferred that 0.8 ≤ a3 ≤ 1.2, 0.75 ≤ x3 < 1, 0 < y3 ≤ 0.25, 0 ≤ z3 ≤ 0.2, -0.2 ≤ b3 ≤ 0.2 and x3 + y3 + z3 = 1. It may also be preferred that 0.8 ≤ a3 ≤ 1.2, 0.75 ≤ x3 < 1, 0 < y3 ≤ 0.25, 0 ≤ z3 ≤ 0.2, -0.2 ≤ b3 ≤ 0.2, x3 + y3 + z3 = 1, and A = Mg alone or in combination with one or more of Al, V, Ti, B, Zr, Cu, Sn, Cr, Fe, Ga, Si, Zn, Sr, and Ca. It may also be preferred that 0.8 ≤ a3 ≤ 1.2, 0.75 ≤ x3 < 1, 0 < y3 ≤ 0.25, 0 ≤ z3 ≤ 0.2, -0.2 ≤ b3 ≤ 0.2, x + y + z = 1, and A = Al alone or in combination with one or more of Mg, V, Ti, B, Zr, Cu, Sn, Cr, Fe, Ga, Si, Zn, Sr, and Ca. It may be further preferred that 0.8 ≤ a3 ≤ 1.2, 0.75 ≤ x3 < 1, 0 < y3 ≤ 0.25, 0 ≤ z3 ≤ 0.2, -0.2 ≤ b3 ≤ 0.2, x3 + y3 + z3 = 1, and A = Al and Mg alone or in combination with one or more of V, Ti, B, Zr, Cu, Sn, Cr, Fe, Ga, Si, Zn, Sr, and Ca.

The second lithium nickel composite oxide particles are in the form of secondary particles which comprise a plurality of crystal grains (also known as primary particles) which may be made up from one or more crystallites. The crystal grains are separated by grain boundaries. Typically, the second particulate lithium nickel composite oxide material is formed from crystal grains with a size of less than 250 nm, such as from 1 to 250 nm. The size of the crystal grains (the length of the longest particle dimension) may be observed by scanning electron microscopy.

It may be preferred that the second lithium nickel composite oxide material comprises a surface layer, the surface layer comprising a higher concentration of cobalt and / or aluminium than is present in the core of the particles.

Alternatively, or in addition, it may be preferred that the second lithium nickel composite oxide material comprises enriched grain boundaries, i.e. the concentration of one or more metals at the grain boundaries is greater than the concentration of the one or more metals in the crystal grains. It may be preferred that the concentration of cobalt at the grain boundaries between the crystal grains of the second lithium nickel composite oxide material is greater than the concentration of cobalt in the crystal grains. Alternatively, or in addition, it may be further preferred that the concentration of aluminium at the grain boundaries between the crystal grains is greater than the concentration of aluminium in the crystal grains. The enrichment of grain boundaries with cobalt and / or aluminium offers protection from particle degradation and improved electrode lifetime.

The difference between the concentration of cobalt and / or aluminium in the crystal grains and at the grain boundaries may at least 1 atom %, e.g. at least 3 atom % or at least 5 atom % (calculated by subtracting the concentration of cobalt in the primary particles in atom % from the concentration of cobalt at the grain boundaries in atom %).

The concentration of a metal, such as cobalt or aluminium, at the grain boundaries and in the crystal grains may be determined by energy dispersive X-ray spectroscopy (EDX) analysis of the centre of a grain boundary and the centre of an adjacent crystal grain for a thinly sliced (e.g. 100-150 nm thick) section of a particle by a sectioning technique such as focused ion beam milling.

Typically, the second particulate lithium nickel composite oxide material has a volume-based particle size distribution such that the D50 of at least 3 µm, e.g. at least 4 µm, at least 5 µm. The particles of the second particulate lithium nickel composite oxide material typically have a volume-based particle size distribution such that the D50 is 30 µm or less, e.g. 25 µm or less or 12 µm or less. It may be preferred that the particles of second particulate lithium nickel composite oxide material have a D50 in the range of and including of 3 µm to 30 µm, such as between 4 µm and 25 µm, or 5 µm and 20 µm. The term D50 as used herein refers to the median particle diameter of a volume-weighted distribution. The D50 may be determined by using a laser diffraction method (e.g. by suspending the particles in water and analysing using a Malvern Mastersizer 2000).

Preferably the D50 of the first particulate lithium nickel composite oxide material is less than the D50 of the second particulate lithium nickel composite oxide material. It may be further preferred that the D50 of the first particulate lithium nickel composite oxide material is in the range of and including 2 to 9 µm (preferably 2 to 7 µm) and the D50 of the second particulate lithium nickel composite oxide material is in the range of and including of 5 µm to 20 µm. It may be even more preferred that the D50 of the first particulate lithium nickel composite oxide material is in the range of and including 2 to 6 µm and the D50 of the second particulate lithium nickel composite oxide material is in the range of and including of 8 µm to 15 µm.

The first and second particulate lithium nickel composite oxide materials may be blended as powders or may be combined during the formation of an electrode slurry.

A positive electrode active material may be formed by mixing the first and second particulate lithium nickel composite oxide materials, for example using a shaker mixer. Typically, the first particulate lithium nickel composite oxide material comprises 10 to 90 wt% of the positive electrode active material. It may be preferred that the first particulate lithium nickel composite oxide material comprises 10 to 80 wt% of the positive electrode active material, 10 to 70 wt% of the positive electrode active material, 10 to 60 wt% of the positive electrode active material or 15 to 50 wt% of the positive electrode active material. It may be particularly preferred that the first particulate lithium nickel composite oxide material comprises 20 to 40 wt% of the positive electrode active material. Computational modelling indicates that the inclusion of 20 to 40 wt% of the first particulate material offers optimal packing of the blended components.

The first particulate lithium nickel composite oxide material, or a combination of the first and second particulate lithium nickel composite oxide material, may be advantageously used to form an electrode.

The formation of an electrode may be achieved by a method comprising the step of through a forming an electrode slurry comprising the first particulate lithium nickel composite oxide material, or the first and the second particulate lithium nickel composite oxide materials. The slurry additionally comprises one or more of a solvent, a binder, carbon material and further additives. It will be understood by the skilled person that the electrode slurry may be formed by the mixing of a positive electrode active material comprising the first and second particulate lithium nickel composite oxide materials with the other slurry components, or by the separate addition of the first and second particulate lithium nickel composite oxide materials to the other slurry components in the desired ratio.

Preferably, the electrode slurry comprises a weight ratio of the first to the second lithium nickel composite oxide materials of from 1:9 to 1:1. It may be particularly preferred that electrode slurry comprises a weight ratio of the first to the second lithium nickel composite oxide materials of from 1:4 to 1:2.5.

To form an electrode the slurry is applied to the surface of a current collector (e.g. an aluminium current collector) dried. The electrode is then calendared to increase the density of the electrode. Advantageously, the use of a combination of the first and second electrode active materials enables high electrode density (> 3.3 g/cm³) to be achieved without the use of high calendaring pressure which can lead to particle damage and reduced electrode lifespan.

Typically, electrodes of the present invention will have an electrode density of at least 2.5 g/cm³, at least 2.8 g/cm³ or at least 3 g/cm³. It may have an electrode density of 4.5 g/cm³ or less, or 4 g/cm³ or less, for example a density of from 3 g/cm³ to 4 g/cm³. The electrode density is the electrode density (mass/volume) of the electrode, not including the current collector the electrode is formed on. It therefore includes contributions from the active material, any additives, any additional carbon material, and any remaining binder.

Preferably, the electrode formation is carried out such that the electrode comprises the first particulate lithium nickel composite oxide material substantially in the form of monolithic particles. This may be observed by SEM.

The process of the present invention may further comprise constructing a battery or electrochemical cell including the electrode comprising the materials described herein. The battery or cell typically further comprises an anode and an electrolyte. The battery or cell may typically be a secondary (rechargeable) lithium (e.g. lithium ion) battery.

The present invention will now be described with reference to the following examples, which are provided to assist with understanding the present invention and are not intended to limit its scope.

### EXAMPLES

### Measurement of Volume-Based Particle Size Distribution Parameters

A sample of the lithium nickel composite oxide material was added to water. The obtained dispersion was subjected to a particle size distribution measurement using a laser scattering particle size distribution measuring apparatus (Mastersizer MS3000, manufactured by Malvern Instruments Ltd.), whereby the volume-based particle size distribution was measured. From the obtained cumulative particle size distribution curve, the particle diameter (D50) at a 50% cumulation measured from the smallest particle side is determined. Similarly, the particle diameter (D10) at a 10% cumulation measured from the smallest particle side is determined as the 10% cumulative diameter, and the particle diameter (D90) at a 90% cumulation measured from the smallest particle side is determined as the 90% cumulative diameter.

### Measurement of Average Primary Particle Size

A sample of the lithium nickel composite oxide material is analysed using a scanning electron microscope (SEM), with observation is performed at a magnification of 1,000 to 10,000 in accordance with the particle size. About two hundred particles having recognisable profiles are selected for image analysis. The average primary particle size was determined as the arithmetic average of the equivalent spherical diameters of the selected particles.

### Powder X-ray Diffraction Measurement and Derivation of Crystallite Size

PXRD data was collected in reflection geometry using a Bruker AXS D8 diffractometer using Cu Kα radiation (λ = 1.5406 +1.5444 Å). A dataset was collected between 2θ = 10 - 130° in 0.02 ° steps. Phase identification was conducted using Bruker AXS Diffrac Eva V5 (2019) with reference to the PDF-4+ database, to ensure that all of the observed scattering could be assigned to known crystal structures. Rietveld refinement was performed using Bruker-AXS Topas 5 between 2θ = 17 - 70 ° where the instrumental parameters were determined using a fundamental parameters approach using reference data collected from NIST660 LaB₆.

### Example 1: Formation of a Lithium Nickel Composite Oxide Precursor

A lithium nickel composite oxide precursor of formula Ni_{0.91}Co_{o.o8}Mg_{0.01}(OH)₂ was prepared as follows. A mixed metal sulphate solution at a total metal concentration of 1.33 M was prepared by dissolving nickel (II) sulphate hexahydrate (636.9 g), cobalt (II) sulphate heptahydrate (59.23 g), and magnesium sulphate heptahydrate 6.49 g) in water (amount added to achieve a solution volume of 2L).

The mixed metal sulfate solution, a NaOH solution (25 wt%), and an ammonia solution (prepared by diluting 28% NH₃ (560 mL) with 440 ml of distilled water), were co-fed to a sealed and jacketed reaction vessel containing distilled water (1.36 L). The reaction temperature was maintained at 60° C. and the pH of the reaction mixture kept at a target pH of 10.6 by varying the sodium hydroxide addition rate. The rate of addition of the ammonia solution and the mixed metal sulphate solution were set so as to achieve an ammonia :MSO₄ molar ratio of 2:1. After complete addition, the reaction was stirred at 60° C. for 20 h.

The slurry was then filtered, and the material washed with distilled water (6 x1 L) before drying to yield the precursor material (165 g). The material was analysed by ICP-OES which confirmed the desired elemental composition.

The particle size distribution was measured using a Malvern Mastersizer 3000 which provided a mean D50 value of 3.43 µm.

The precursor material was also analysed by scanning electron microscopy (SEM) (FIG. 1) which indicated that the precursor material was formed from secondary particles comprising a plurality of crystal grains (primary particles).

### Example 2 - Preparation of a Lithium Nickel Composite Oxide Material (Li_{1.02} Ni_{0.91} Co_{0.08} Mg_{0.01} O₂).

The nickel metal precursor prepared in Example 1 (20 g) was blended with LiOH (5.25 g) and then blended in a Turbula mixer for 30 mins. The mixture was then placed in a saggar and calcined under an oxygen flow (2 L /min) using the following calcination profile: heating at 5° C./min to a temperature of 450° C. and holding for 2 h at 450° C., heating at 2° C./min to a temperature of 700° C. and holding for 6 h at 700° C., heating at 10° C./min to a temperature of 800° C. and holding for 6 h at 800° C. The sample was cooled to 100° C. and then transferred to a glove box. The sample was then ground using a pestle and mortar and sieved using a 56 µm sieve under an inert atmosphere.

The material was analysed by ICP-MS which confirmed the desired elemental composition. The material was also analysed by powder x-ray diffraction which indicated that the material had the desired α—NaFeO₂—type structure.

The particle size distribution was measured using a Malvern Mastersizer 3000 which provided a mean D50 value of 5.45 µm.

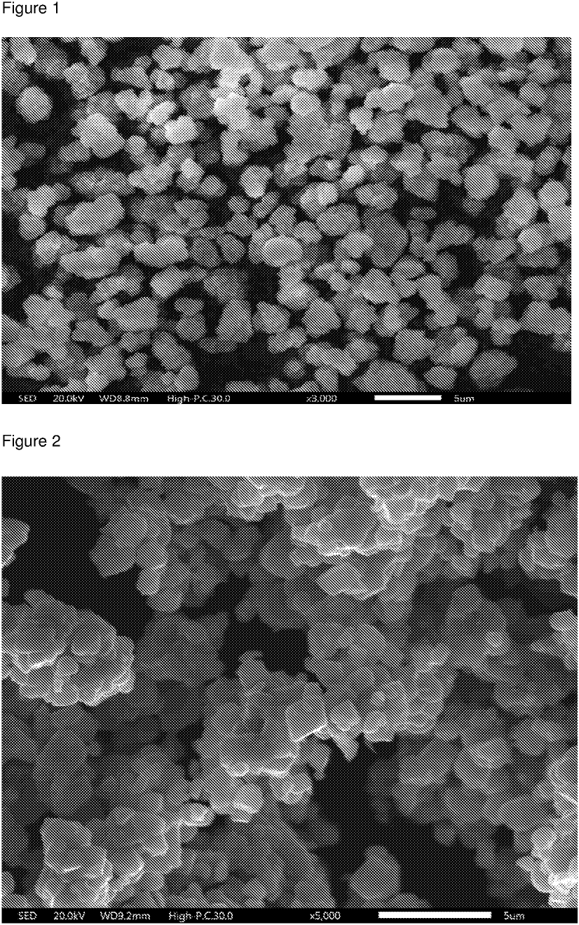

The lithium nickel composite oxide material was also analysed by scanning electron microscopy (SEM) (FIG. 2) which indicated that the lithium nickel composite oxide material was formed from primary particles with a typical particle size 0.5 to 2 µm.

### Example 3 - Variation in Calcination Profile and Post Calcination Milling

The calcination profile was investigated by repeating the method of Example 2 but with variation of the calcination profile as shown in Table 1. Examples 2N and 2Q were carried out in a larger scale using 80 g of precursor material. The material formed in Example 2Q was milled to achieve a D90 < 10 µm.

TABLE 1

Variation in temperature profile during calcination experiments

| Example | Temperature profile | | | | | |
|---|---|---|---|---|---|---|
| | 1 ramp | dwell | 2 ramp | dwell | 3 ramp | dwell |
| 2A | 5° C./min | 450° C./2 h | 2° C./min | 700° C./6 h | 10° C./min | 900° C./6 h |
| 2B | 5° C./min | 450° C./2 h | 2° C./min | 700° C./6 h | 10° C./min | 850° C./6 h |
| 2C | 5° C./min | 450° C./2 h | 2° C./min | 700° C./6 h | 10° C./min | 800° C./6 h |
| 2D | 5° C./min | 450° C./2 h | 2° C./min | 700° C./6 h | 10° C./min | 750° C./6 h |
| 2E | 5° C./min | 450° C./2 h | 2° C./min | 700° C./6 h | 10° C./min | 800° C./6 h |
| 2F | 5° C./min | 450° C./2 h | 2° C./min | 700° C./6 h | 10° C./min | 780° C./6 h |
| 2G | 5° C./min | 450° C./2 h | 2° C./min | 700° C./6 h | 10° C./min | 800° C./6 h |
| 2H | 5° C./min | 450° C./2 h | 2° C./min | 700° C./6 h | 10° C./min | 820° C./6 h |
| 2I | 5° C./min | 450° C./2 h | 2° C./min | 700° C./6 h | 10° C./min | 820° C./6 h |
| 2J | 5° C./min | 450° C./2 h | 2° C./min | 700° C./6 h | 10° C./min | 800° C./6 h |
| 2K | 5° C./min | 450° C./2 h | 2° C./min | 700° C./6 h | 10° C./min | 800° C./6 h |
| 2L | 5° C./min | 450° C./2 h | 2° C./min | 700° C./6 h | 10° C./min | 800° C./6 h |
| 2M | 5° C./min | 450° C./2 h | 2° C./min | 700° C./6 h | 10° C./min | 800° C./10 h |
| 2N | 5° C./min | 450° C./2 h | 2° C./min | 700° C./6 h | 10° C./min | 800° C./10 h |
| 2O | 5° C./min | 450° C./2 h | 2° C./min | 700° C./6 h | 10° C./min | 800° C./20 h |
| 2P | 5° C./min | 450° C./2 h | 2° C./min | 700° C./6 h | 10° C./min | 800° C./40 h |
| 2Q | 5° C./min | 450° C./2 h | 2° C./min | 700° C./6 h | 10° C./min | 800° C./10 h |
| 2R | - | - | 3° C./min | 700° C./6 h | 10° C./min | 800° C./6 h |
| 2S | 5° C./min | 450° C./2 h | - | - | 10° C./min | 800° C./6 h |
| 2T | - | - | 3° C./min | 700° C./3 h | 10° C./min | 800° C./6 h |

The materials formed from Example 2A to 2T were analysed for lithiation level (ratio of the amount of lithium to non-lithium metals by Inductively Coupled Plasma Mass Spectrometry (ICP-MS), for XRD characteristics and for particle size (Table 2).

TABLE 2

The results of analysis of the material produced in Examples 2A to 2T (“-” = not tested)

| Example | ICP Li/M ratio | XRD | | PSD | | |
|---|---|---|---|---|---|---|
| | | a | c | D10 | D50 | D90 |
| 2A | 1.00 | 2.879 | 14.198 | - | - | - |
| 2B | 1.01 | 2.876 | 14.190 | - | - | - |
| 2C | 1.01 | 2.875 | 14.186 | 2.38 | 5.21 | 19.10 |
| 2D | 1.02 | 2.873 | 14.189 | 2.93 | 5.63 | 12.00 |
| 2E | 1.03 | 2.874 | 14.184 | 2.87 | 7.32 | 21.90 |
| 2F | 1.03 | 2.873 | 14.183 | 2.54 | 5.30 | 16.00 |
| 2G | - | - | - | 2.28 | 5.52 | 22.50 |
| 2H | 1.01 | 2.874 | 14.188 | - | - | - |
| 2I | 1.01 | 2.875 | 14.187 | - | - | - |
| 2J | 1.01 | 2.874 | 14.185 | - | - | - |
| 2K | 1.02 | 2.875 | 14.188 | - | - | - |
| 2L | 1.03 | 2.874 | 14.188 | - | - | - |
| 2M | 1.04 | 2.875 | 14.187 | - | - | - |
| 2N | 1.02 | 2.874 | 14.188 | 3.74 | 8.09 | 16.70 |
| 2O | 1.04 | 2.874 | 14.183 | - | - | - |
| 2P | 1.01 | 2.875 | 14.189 | - | - | - |
| 2Q | - | 2.874 | 14.188 | 1.83 | 3.19 | 5.86 |
| 2R | 1.01 | - | - | - | - | - |
| 2S | - | - | - | - | - | - |
| 2T | 1.01 | - | - | 3.19 | 6.63 | 21.8 |

This data indicated that increasing the temperature of the third dwell to 900° C. (Example 2A) leads to an increase in c-parameter derived from the XRD in comparison with lower temperature calcinations.

SEM analysis of the material produced in Example 2D indicated that that a temperature of 750° C. for the third dwell was not sufficient to form primary particles within the desired particle range. This material was not subjected to electrochemical testing. The average primary particle size for the material formed in Example 2Q by SEM analysis was 1.04 µm.

For other materials, SEM analysis indicated an average primary particle size in the range of 0.5 to 4 µm.

### Example 5 - Formation of Secondary Particles of Li_{1.02}Ni_{0.91}Co_{0.08}Mg_{0.01}O₂ Using a Calcination Profile Without a High Temperature Hold (Comparative Example).

The nickel metal precursor prepared in Example 1. The material was converted according to a lithium nickel composite oxide material of formula Li_{1.02}Ni_{0.91}Co_{0.08}Mg_{0.01}O₂ using an analogous method to that of Example 2 however the calcination profile was as follows: heating at 5° C./min to a temperature of 450° C. and holding for 2 h at 450° C., heating at 2° C./min to a temperature of 700° C. and holding for 6 h at 700° C. before cooling.

### Example 6 - Formation of Secondary Particles of Li_{1.02}Ni_{0.91}Co_{0.08}Mg_{0.01}O₂ (Using 10 µm Precursor) Using Standard Calcination Profile Without a High Temperature Hold (Comparative Example)

A lithium nickel composite oxide precursor of formula Ni_{0.91}Co_{0.08}Mg_{0.01}(OH)₂ and with a D50 of 10 µm was produced using an analogous method to Example 1. The material was converted according to a lithium nickel composite oxide material of formula Li_{1.02}Ni_{0.91}Co_{0.08}Mg_{0.01}O₂ using an analogous method to that of Example 2 however the calcination profile was as follows:

heating at 5° C./min to a temperature of 450° C. and holding for 2 h at 450° C., heating at 2° C./min to a temperature of 700° C. and holding for 6 h at 700° C. before cooling.

### Example 7 - Example Preparation of Secondary Particles of Li_{1.02}Ni_{0.87}Co_{0.11}Mg_{0.01}Al_{0.01}O₂ With Cobalt and Aluminium Grain Boundary Enrichment.

An aqueous solution containing 11.745 g Co(NO₃)₂0.6H₂O, 1.855 g LiNO₃ and 2.422 g Al(NO₃)₃0.9H₂O in 100 mL water was heated to between 60 and65° C. 100 g of a base material formed according to a method analogous to Example 6 was added rapidly while stirring vigorously. The slurry was stirred at a temperature between 60 and 65° C. until the supernatant was colourless. The slurry was then spray-dried.

After spray-drying powders were loaded into 99%+ alumina crucibles and calcined under an artificial CO₂-free air mix which was 80:20 N₂:O₂. Calcination was performed as follows: ramp to 130° C. (5° C./min) with 5.5 hours hold, ramp to 450° C. (5° C./min) with 1 hour hold, ramp to 700° C. (2° C./min) with a 2 hours hold and cooled naturally to 130° C. The artificial air mix was flowing over the powder bed through the calcination and cooling. The title compound was thereby obtained. The samples were then removed from the furnace at 130° C. and transferred to a purged N₂-filled glove-box.

The sample was milled in a high-alumina lined mill pot on a rolling bed mill. The target end point of the milling was when D50 was between 10 and 11 µm; D50 was measured after milling and found to be 9.5 µm. The sample was passed through a 53 µm sieve and stored in a purged N₂ filled glove-box.

Samples of lithium nickel composite oxide materials produced according to this method have been analysed by FIB-TEM (Focussed Ion Beam-Transmission Electron Microscopy). The images show that the grain boundaries between the crystal grains, and the surface of the secondary particles, show cobalt and aluminium enrichment, with a higher cobalt and aluminium concentration at the grain boundaries and at the surface than is present in the crystal grains.

### Example 8 - Formation of a Blended Positive Electrode Active Material

Example 8A - A sample of a material formed according to Example 7 (70 wt%) was mixed with a material formed according to the method of Example 2 (30 wt%). The materials were mixed in a Turbula mixer for 30 minutes.

Example 8B - A sample of a material formed according to Example 7 (75 wt%) was mixed with a material formed according to the method of Example 2 (25 wt%). The materials were mixed in a Turbula mixer for 30 minutes.

### Example 9 - Formation and SEM Analysis of Electrodes Formed From the Material of Example 2 or Example 6.

Electrodes were printed using an electrode formulation of active material:C65:PDVF (94:3:3) and gap blade (125 µm). After printing electrodes are dried in the oven at 120° C. for 1h. The electrodes were pressed using a calender roller to a density between 3.0 - 3.3 g/cm³.

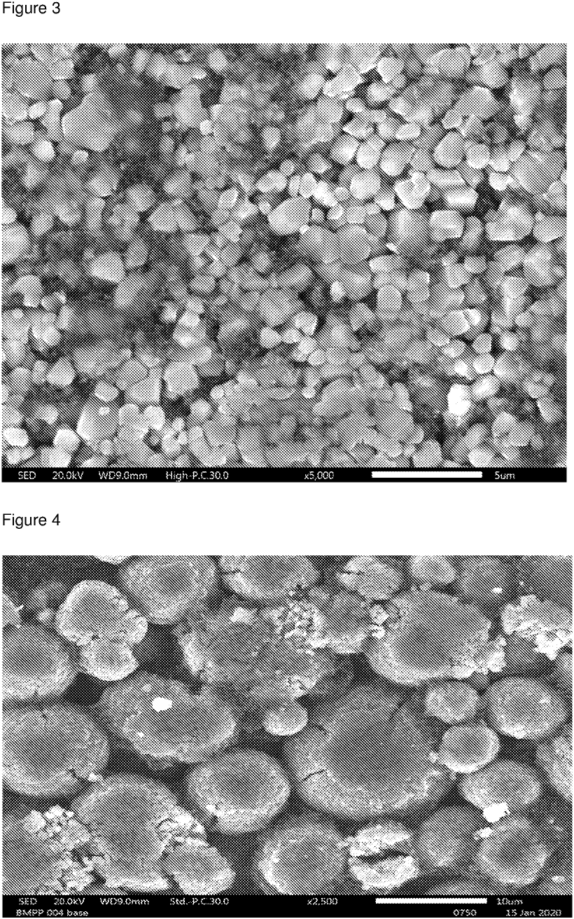

Electrode A comprised the lithium nickel composite oxide material of Example 2. Electrode B comprised a lithium nickel composite oxide material formed according to the method of Example 6. SEM analysis of Electrode A (FIG. 3) shows the active material is present as monolithic particles with no significant primary particle cracking. In contrast, SEM analysis of Electrode B (FIG. 4) shows particle cracking has occurred.

### Example 10 - Formation and SEM Analysis of an Electrodes Comprising the Material of Example 7 or the Blended Compositions of Example 8A and 8B.

Electrodes were printed incorporating either (i) a surface-modified lithium nickel composite oxide material produced according to the method of Example 7 (30 electrodes, Electrodes C); or (ii) a blended composition according to Example 8A (30 electrodes, Electrodes D); or (iii) a blended composition according to Example 8B (30 electrodes, Electrodes E).

The electrodes were formed using an electrode formulation of 94:3:3 (Active:C65:PVDF) and gap blade (300 µm). The electrodes were dried in the oven at 120° C. for 1 h. The average electrode loading for the electrodes C (prior to any densification step) was 2.37 g/cm³ and for electrodes D (prior to any densification step) was 2.57 g/cm³.

The evolution of electrode density with increasing pressure loads was then investigated. An electrode density of 3.3 g/cm³ is taken as a target value. FIG. 5 shows the increase in density with increased uniaxial pressure applied to Electrodes C. In order to achieve 3.3 g/cm³, a load of 9 tonnes needs to be applied with a uniaxial press for Electrodes C.

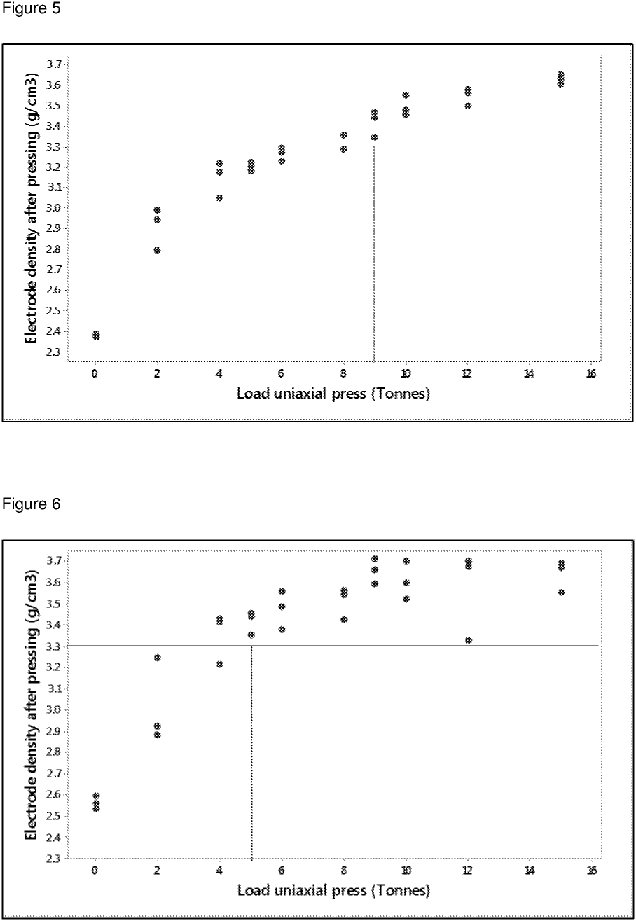

FIG. 6 shows the increase in density with increased uniaxial pressure applied to Electrodes D. In order to achieve 3.3 g/cm³, a load of 5 tonnes needs to be applied with a uniaxial press for Electrodes D.

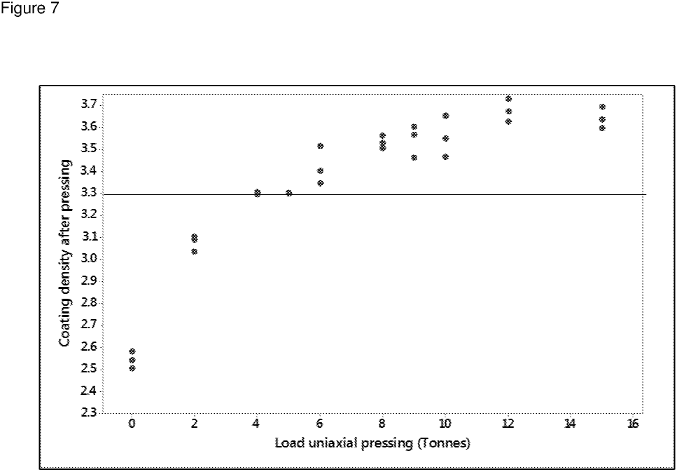

FIG. 7 shows the increase in density with increased uniaxial pressure applied to Electrodes D. In order to achieve 3.3 g/cm³, a load of 5 tonnes needs to be applied with a uniaxial press for Electrodes E.

Around 50% less pressure is required for the electrode system incorporating the blended lithium nickel composite oxide materials.

Electrodes C and D were analysed by SEM. For Electrode C, a load of 9 tonnes is required to achieve a density of 3.3 g/cm³. SEM analysis indicated that, at this pressure, the spheres at the surface of the electrode are considerably damaged and squashed. The Electrode D requires 5 tonnes to achieve a density of 3.4 g/ cm³ and minimal particle damage is observed by SEM. If a similar load of 9 tonnes is applied to Electrode D then some surface damage is observed by SEM but the density reaches 3.7 g/cm³.

### Electrochemical Testing

Electrochemical Protocol: The pressed electrodes were cut into 14 mm disks and further dried at 120° C. under vacuum for 12 hours.

Electrochemical testing was performed with a CR2025 coin-cell type, which was assembled in an argon filled glove box (MBraun). Lithium foil was used as an anode. A porous polypropylene membrane (Celgard 2400) was used as a separator. 1 M LiPF₆ in 1:1:1 mixture of ethylene carbonate (EC), dimethyl carbonate (DMC) and ethyl methyl carbonate (EMC) with 1% of vinyl carbonate (VC) was used as electrolyte.

The cells were tested on a MACCOR 4000 series using C-rate and retention tests using a voltage range of between 3.0 and 4.3 V. The C-rate test charged and discharged cells at 0.1 C and 5 C (0.1 C = 200 mAh/g). The capacity retention test was carried out at 1 C with samples charged and discharged over 50 cycles.

The results of the testing of materials produced in Example 2 and Example 5 are provided in Table 3. The data indicates that calcination at 900° C. led to a significant reduction in capacity retention after repeated charge-discharge cycles. Reduction of the D90 (Example 2Q) led to an increased capacity retention. Capacity retention was also increased by a 40 h third dwell (Example 2P) but this was accompanied by a reduction in first cycle discharge capacity. Removal of the dwell at 700° C. (Example 2S) has a detrimental impact on cycle life retention.

TABLE 3

Electrochemical results - Example 2 and Example 5

| | Cycle life Retention (%) |
|---|---|
| Example 2A | 75 |
| Example 2B | 92 |
| Example 2C | 92 |
| Example 2E | 88 |
| Example 2F | 89 |
| Example 2G | 92 |
| Example 2H | 91 |
| Example 2l | 90 |
| Example 2J | 91 |
| Example 2K | 91 |
| Example 2L | 92 |
| Example 2M | 91 |
| Example 2N | 90 |
| Example 2O | 92 |
| Example 2P | 95 |
| Example 2Q | 94 |
| Example 5 | 91 |
| Example 2R | 92 |
| Example 2S | 89 |
| Example 2T | 92 |

Electrochemical results (Electrodes produced in Example 10):

Electrodes formed in Example 10 with equivalent electrode densities were tested using the electrochemical protocol set out above. The results are shown in Table 4. This data indicates that blended materials provide equivalent discharge capacity to the secondary particles alone. The blended materials advantageously provide an enhanced retention of discharge capacity at high discharge rates.

TABLE 4

Electrochemical results generated on electrodes produced in Example 10.

| | Electrode C | Electrode D |
|---|---|---|
| Active Loading (mg/cm2) | 23.5 | 22.6 |
| Electrode density (g/cm3) | 3.2 | 3.3 |
| FCC (mAh/g) | 233 | 236 |
| FCE (%) | 88.4 | 88.3 |
| 0.1 C Capacity | 207 | 209 |
| 2.0 C/0.1 C Capacity (%) | 57 | 64 |
| 3.0 C/0.1 C Capacity (%) | 29 | 35 |

1. A particulate lithium nickel composite oxide material satisfying the following requirements:
(i) the lithium nickel composite oxide has a composition according to formula (1): 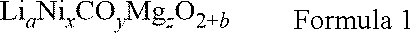
in which:
$$0.8 \leq \text{a} \leq \text{1} \text{.2}$$
$$0.7 \leq \text{x} \leq \text{1}$$
$$0 \leq \text{y} \leq \text{0} \text{.3}$$
$$0 < \text{z} \leq \text{0} \text{.2}$$
$$\text{-0} \text{.2} \leq \text{b} \leq \text{0} \text{.2}$$
$$\text{x + y + z = 1;}$$
(ii) the lithium nickel composite oxide material has a volume-based particle size distribution such that the D50 is in the range of and including 2 to 7 µm;
(iii) the average primary particle size of the lithium nickel composite oxide material is in the range of and including 0.5 to 4 µm.

2. The particulate lithium nickel composite oxide material according to claim 1, wherein 0.85 ≤ x < 1, 0 < y ≤ 0.15, and 0 < z ≤ 0.10.

3. The particulate lithium nickel composite oxide material according to claim 1, wherein the D50 is in the range of and including 2 to 5 µm.

4. The particulate lithium nickel composite oxide material according to claim 1, wherein the average primary particle size is in the range of and including 0.5 to 2 µm.

5. The particulate lithium nickel composite oxide material according to claim 1, wherein the length of the c-axis of the lithium nickel composite oxide materials is less than 14.190 angstrom as determined by a Rietveld analysis of the powder x-ray diffraction pattern.

6. The particulate lithium nickel composite oxide material according to claim 1, wherein the material has a particle size distribution characterised by D90 <10 µm.

7. A process for preparing a lithium nickel composite oxide material according to claim 1, the process comprising the steps of:
(i) providing a precursor of the lithium nickel composite oxide with a volume-based particle size distribution such that the D50 is in the range of and including 1 to 7 µm;
(ii) mixing the precursor with at least one lithium-containing compound;
(iii) calcining the mixture to form the lithium nickel composite oxide material, the calcination comprising heating to a temperature in the range of and including 650° C. to 725° C. for a period of from 2 to 8 hours; and subsequently heating to a temperature in the range of and including 775° C. to 875° C.

8. The process according to claim 7 wherein the lithium-containing compound is lithium hydroxide.

9. The process according to claim 7, wherein the precursor is a nickel metal hydroxide.

10. A process according to claim 7, wherein the precursor is in the form of secondary particles comprising a plurality of crystal grains.

11. A process according to claim 7, wherein the calcination step is carried out under an atmosphere comprising at least 90 vol % oxygen.

12. A process according to claim 7, wherein the mixture is heated to a temperature in the range of and including 775° C. to 875° C. for a period of 4 to 20 hours.

13. A process according to claim 7, wherein the calcination comprises a step of heating at a temperature in the range of and including 400° C. to 500° C. for a period of 1 to 4 hours prior to the step of heating to 650° C. to 725° C.

14. A process according to claim 7, wherein the process further comprises the step of coating the lithium nickel composite oxide.

15. The process according to claim 7 wherein the process further comprises the step of milling the lithium nickel composite oxide.

16. The process according to claim 7, wherein the process further comprises the step of forming an electrode comprising the lithium nickel composite oxide material.

17. (canceled)

18. (canceled)

19. A positive electrode active material comprising:
(i) a first particulate lithium nickel composite oxide with a composition according to 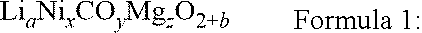
in which:
$$0.8 \leq \text{a} \leq \text{1} \text{.2}$$
$$0.7 \leq \text{x < 1}$$
$$0 \leq \text{y} \leq \text{0} \text{.3}$$
$$0 < \text{z} \leq \text{0} \text{.2}$$
$$\text{-0} \text{.2} \leq \text{b} \leq \text{0} \text{.2}$$
$$\text{x + y + z = 1;}$$
and with an average primary particle size in the range of and including 0.5 to 4 µm; and
(ii) a second particulate lithium nickel composite oxide material in the form of secondary particles comprising a plurality of crystal grains separated by grain boundaries.

20. The positive electrode active material according to claim 19 wherein the second particulate lithium nickel composite oxide material has a composition according to Formula 3: 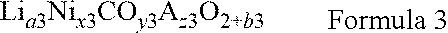
in which:
A is one or more of Al, V, Ti, B, Zr, Cu, Sn, Cr, Fe, Ga, Si, Zn, Mg, Sr, Mn, and Ca;
$$0.8 \leq \text{a} \leq \text{1} \text{.2}$$
$$0.5 \leq \text{x3 < 1}$$
$$0 \leq \text{y3} \leq \text{0} \text{.5}$$
$$0 < \text{z3} \leq \text{0} \text{.2}$$
$$\text{-0} \text{.2} \leq \text{b3} \leq \text{0} \text{.2}$$
$$\text{x3 + y3 + z3 = 1}$$
.

21. The positive electrode active material according to claim 19, wherein (a)_the particles of the second particulate lithium nickel composite oxide material comprise a surface layer, the surface layer comprising a higher concentration of cobalt and / or aluminium than is present in the core of the particles, (b) the concentration of cobalt at the grain boundaries of the second particulate lithium nickel composite oxide material is greater than the concentration of cobalt in the crystal grains of the second particulate lithium nickel composite oxide material, (c) the concentration of aluminium at the grain boundaries of the second particulate lithium nickel composite oxide material is greater than the concentration of aluminium in the crystal grains of the second particulate lithium nickel composite oxide material, (d) the second particulate lithium nickel composite oxide material has a volume-based particle size distribution such that the D50 is in the range of and including 5 to 20 µm, (e) wherein the first particulate lithium nickel composite oxide material has a volume-based particle size distribution such that the D50 is in the range of and including 2 to 7 µm, or (f) wherein the crystal grains of the second particulate lithium nickel composite oxide material have a size less than 250 nm, or any two or more of (a) - (f).

22. (canceled)

23. (canceled)

24. (canceled)

25. (canceled)

26. (canceled)

27. (canceled)

28. A method of forming an electrode comprising the steps of:
(i) forming an electrode slurry comprising (a) a first particulate lithium nickel composite oxide material with a composition according to Formula 1 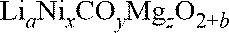
in which:
$$0.8 \leq \text{a} \leq \text{1} \text{.2}$$
$$0.7 \leq \text{x < 1}$$
$$0 \leq \text{y} \leq \text{0} \text{.3}$$
$$0 < \text{z} \leq \text{0} \text{.2}$$
$$\text{-0} \text{.2} \leq \text{b} \leq \text{0} \text{.2}$$
$$\text{x + y + z = 1;}$$
and with an average primary particle size in the range of and including 0.5 to 4 µm; and (b) a second particulate lithium nickel composite oxide material in the form of secondary particles comprising a plurality of crystal grains separated by grain boundaries;
(ii) applying the electrode slurry to a current collector and drying;
(iii) calendaring the electrode.

29. (canceled)

30. (canceled)

31. (canceled)
